(19) United States
(12) Patent Application Publication
(10) Pub. No.: US 2026/0138339 A1
(43) Pub. Date: May 21, 2026

(54) APPARATUS AND METHODS FOR COMPONENT CONNECTIONS VIA BEAD TEXTURE FITTING

(71) Applicant: HITT Holding Corporation, Falls Church, VA (US)

(72) Inventor: Carl ANDERSEN, Falls Church, VA (US)

(73) Assignee: HITT Holding Corporation, Falls Church, VA (US)

(21) Appl. No.: 19/395,177

(22) Filed: Nov. 20, 2025

Related U.S. Application Data
(60) Provisional application No. 63/723,196, filed on Nov. 21, 2024.

(51) Int. Cl. B29C 65/56; B29K 625/00; B33Y 40/00

(52) U.S. Cl. CPC B29C 65/565; B29K 2625/08; B33Y 40/00

(57) ABSTRACT

Systems, methods, and apparatus for attaching additive manufactured components. The systems, methods, and apparatus include large format additive manufacturing (LFAM) component having a LFAM interior surface. The first FDM component may be coupled a large format additive manufacturing (LFAM) component having a LFAM interior surface. The first exterior surface may have a first textured shape that is complementary to the LFAM textured shape. The systems, methods, and apparatus include a second fused deposition modeling (FDM) component having a second exterior surface. The second FDM component may be coupled to the first FDM component.

### CROSS-REFERENCE TO RELATED APPLICATIONS

This application claims priority to U.S. Provisional Application No. 63/723,196, filed Nov. 21, 2024. The disclosure of the above-referenced application is expressly incorporated herein by reference in its entirety.

### TECHNICAL FIELD

The present disclosure generally relates to apparatus and methods for mating additive manufactured components.

### BACKGROUND

The use of 3D printed components, including those printed on large format printers, is growing in popularity. Large format materials, such as printed plastics used in furniture or construction, may be homogenous (e.g., made of the similar or same material), and it may be desirable to recycle such material at the end of its product life cycle by shredding it. Recycling may enable the material to be reprinted into new objects. Traditionally, when attaching components that are 3D printed, metal hardware is used. However, such metal cannot be recycled through the same processes used for materials other than metal (e.g., non-metal materials). For example, recycling methods used for non-metal materials, such as shredding for printed materials, may be different or simpler than recycling methods for metal. Accordingly, the use of metal connection components may increase the time and/or cost associated with recycling printed material, such as labor associated with separating the metal from plastic components. Furthermore, the use of solvents or adhesives may result in connections between components that can weaken over time, as well as inhibiting recycling and presenting environmental concerns (e.g., due to pollution). Thus, there is a need for a new approach that provides a strong attachment between 3D printed components while also enabling the recycling of materials.

### SUMMARY

Disclosed embodiments include systems, methods, and apparatus for attaching additive manufactured components. Some disclosed embodiments include a large format additive manufacturing (LFAM) component having a LFAM interior surface. In some embodiments, the first FDM component may be coupled a large format additive manufacturing (LFAM) component having a LFAM interior surface. The first exterior surface may have a first textured shape that is complementary to the LFAM textured shape. Some disclosed embodiments include a second fused deposition modeling (FDM) component having a second exterior surface. The second FDM component may be coupled to the first FDM component.

In some embodiments, the first exterior surface of the first FDM component may be configured according to one or more layers of the LFAM component.

Some disclosed embodiments involve a friction fit between the LFAM interior surface and the first exterior surface of the first FDM component.

Some disclosed embodiments involve a friction fit between the first interior surface of the first FDM component and the second exterior surface of the second FDM component.

In some embodiments, the first FDM component may be flexible.

In some embodiments, the first FDM component may include at least one extension member.

In some embodiments, a cross-section of the first FDM component may be circular or ovular.

In some embodiments, the LFAM component may include Acrylonitrile styrene acrylate.

Some disclosed embodiments involve providing a large format additive manufacturing (LFAM) component having a LFAM interior surface. The LFAM interior surface may have a LFAM textured shape. Some disclosed embodiments involve configuring a first fused deposition modeling (FDM) component having a first exterior surface and a first interior surface. The first FDM component may be coupled to the LFAM component and the first exterior surface may have a first textured shape configured to be complementary to the LFAM textured shape. Some disclosed embodiments involve inserting the FDM component into the LFAM component. Some disclosed embodiments involve inserting a second FDM component into the first FDM component. The second FDM component may have a second exterior surface and the second FDM component may be coupled to the first FDM component.

### BRIEF DESCRIPTION OF THE DRAWINGS

FIG. 1 is an illustration of a large format additive manufacturing (LFAM) part and a fused deposition modeling (FDM) part, consistent with embodiments of the present disclosure.

FIGS. 2A-2B illustrate an apparatus for attaching additive manufacturing parts, consistent with embodiments of the present disclosure.

FIGS. 3A-3B illustrate a variation of an apparatus for attaching additive manufacturing parts, consistent with embodiments of the present disclosure.

FIGS. 4A-4B illustrate a variation of an apparatus for attaching additive manufacturing parts, consistent with embodiments of the present disclosure.

FIGS. 5A-5B illustrate an apparatus for connecting additive manufacturing parts to furniture, consistent with embodiments of the present disclosure.

FIG. 6 is a flow diagram for a method for connecting additive manufactured components, consistent with embodiments of the present disclosure.

### DETAILED DESCRIPTION

All relative terms such as “about,” “substantially,” “approximately,” etc., indicate a possible variation of ±20% (unless noted otherwise or another variation is specified). For example, a feature disclosed as being about “t” units long (wide, thick, etc.) may vary in length from (t−0.2t) to (t+0.2t) units. Similarly, a temperature within a range of about 100-150° C. can be any temperature between (100-20%) and (150+20%). In some cases, the specification also provides context to some of the relative terms used. For example, a structure described as being substantially circular or substantially cylindrical may deviate slightly (e.g., 20% variation in diameter at different locations, etc.) from being perfectly circular or cylindrical. Further, a range described as varying from 1 to 10(1-10), or between 1 and 10, includes the endpoints (i.e., includes 1 and 10). Unless otherwise defined, all terms of art, notations, and other scientific terms or terminology used herein have the same meaning as is commonly understood by one of ordinary skill in the art to which this disclosure belongs.

Three-dimensional (3D) printed components or parts are used for many different purposes and industries, including construction (e.g., home construction), vehicles (e.g., boats or automobiles), furniture, sculptures, medical devices, or manufacturing applications, as non-limiting examples. 3D printed components, which may refer to components produced through additive manufacturing, can often be cheaper than traditional materials used in furniture or other applications. Further, it will be recognized that there may large amounts of waste associated with traditional materials, such as furniture that is often thrown out with limited ability to reuse the material in the furniture. However, it will be appreciated that 3D printed components are usually made of components that may be easier to recycle or reuse. For example, Large Format Additive Manufacturing (LFAM), which may also be referred to as large format 3D printing or large scale 3D printing, may be a popular example of a technique for manufacturing 3D printed components. Other components made with additive manufacturing can interface with LFAM components to create furniture products or other exemplary applications described herein. Conventionally, components may be attached to LFAM surfaces with the use of metal connectors (e.g., screws, bolts, metal threaded heat-set inserts, or the like), solvents, or adhesives. However, including metal connectors reduces the ease of recycling 3D printed components and may involve increased amounts of labor or costs. The disclosed embodiments involve connectors made through additive manufacturing, thereby enabling easier recycling. The disclosed embodiments include connector apparatuses made through deposition modeling. As such, at the end of its life cycle, 3D printed components including those connected to LFAM components can be fed to a shredder for convenient recycling. The shredder may reduce the printed components down to pellets, enabling the pellet material to be reused for new 3D printed components, which can provide cost and environmental benefits. The disclosed embodiments may involve devices that provide tight connections between different 3D printed components, thereby enabling secure fits and load or torque transmitting capabilities.

A LFAM component may be any component manufactured with LFAM. LFAM components may be large, customized, or durable for a variety of use cases. As a non-limiting example, LFAM materials may include Acrylonitrile Styrene Acrylate (ASA). The disclosed embodiments may involve components that can interface with LFAM components, including any component made through material extrusion. For example, FDM components, such as any component manufactured with FDM, may interface with LFAM components. It may be desired to attach FDM components to LFAM components, such as to connect printed parts for furniture, as described herein. FDM components are not limited to a particular type of filament, and FDM components may include any deposition of polymer pellets along a toolpath, such as Fused Filament Fabrication (FFF), Fused Granule Fabrication (FGF) components, or the like. As a non-limiting example, LFAM and/or FDM materials may include glass, concrete, polymers, composites, or thermoplastics, including polyethylene terephthalate glycol (PETG), Acrylonitrile Butadiene Styrene (ABS), High-Density Polyethylene (HDPE), polycarbonate, Polyetheretherketone (PEEK), or Polylactic acid (PLA).

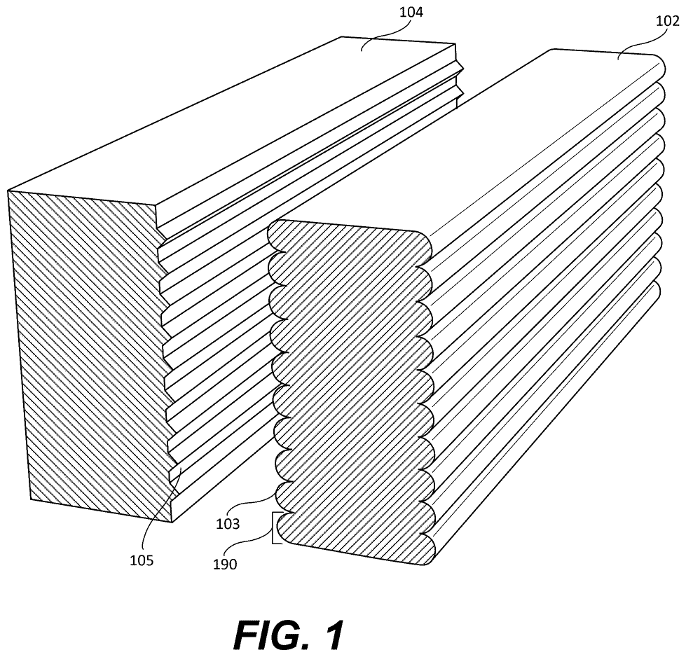

FIG. 1 illustrates an LFAM component and a FDM component, consistent with embodiments of the present disclosure. LFAM component 102 may be any component made with LFAM, as described herein. For example, LFAM component 102 may be a part of a piece of furniture. LFAM component 102 may be formed through material deposition in which material is extruded in layers along a path, thereby creating a stack of layers. As the material may be deposited in a semi-liquid state, the deposition can cause the cross-section of the material to form a pill-shape (e.g., having rounded sides). LFAM textured shape 103 may refer to the shape or texture of LFAM component 102 formed through the stacking of the pill-shaped layers. In some embodiments, FDM component 104 may be configured according to LFAM component 102. For example, FDM component 104 may be formed with extrusion processes that may have higher print resolution or have finer control in manufacturing (e.g., higher fidelity or precision) over LFAM components, due to the large-scale nature of LFAM. Accordingly, the disclosed embodiments include FDM components designed with shapes or textures based on LFAM shapes or textures. For example, FDM component 104 may have a textured shape 105. The textured shape 105 may be configured based on the textured shape 103 of the LFAM component, such as when textured shape 105 may be the inverse of textured shape 103. The layers, dimensions 190 of the layers (e.g., size such as thickness, height, or width), number of layers, and other features of textured shape 105 may be configured such that textured shape 105 may be able to lock into or mate with textured shape 103. For example, troughs or flat portions of textured shape 105 may align with peaks or raised surfaces of textured shape 103, and vice versa, such that when FDM component 104 and LFAM component 102 are brough together, there may be a friction fit between the components. Thus, the disclosed embodiments enable attaching, mating, coupling, or otherwise connecting of additive manufactured components.

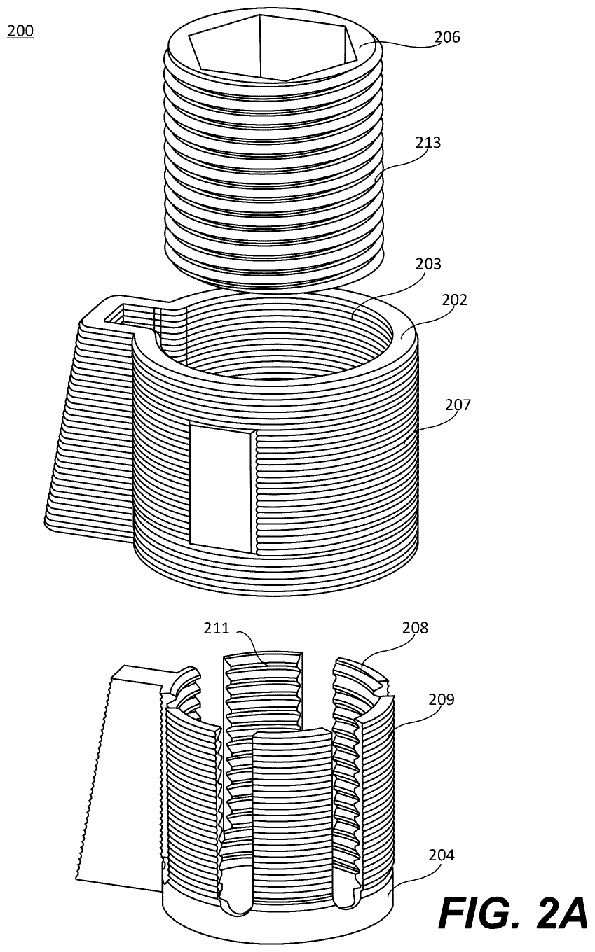

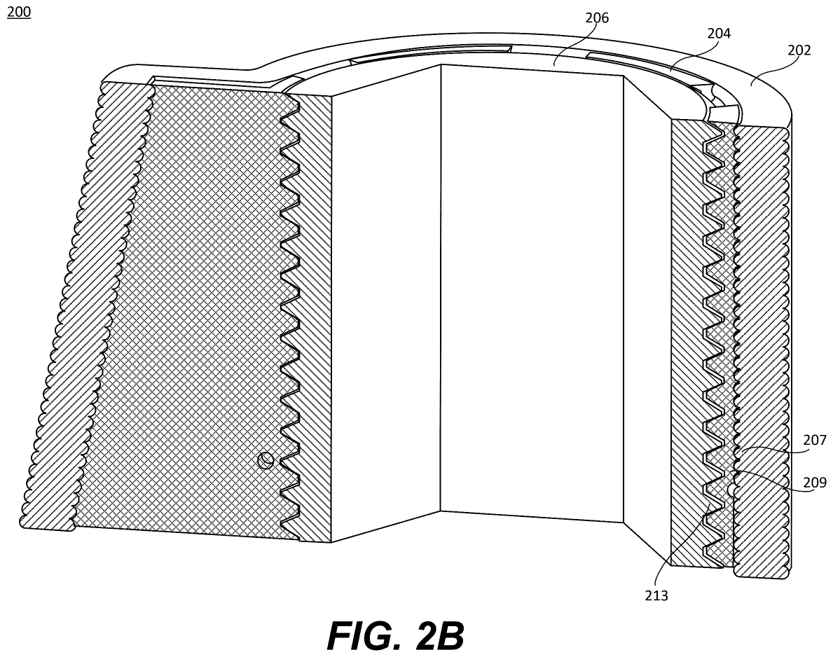

FIG. 2A illustrates an exploded view of an apparatus 200 for attaching additive manufactured components, consistent with embodiments of the present disclosure. Apparatus 200 may include a LFAM component 202, a first FDM component 204, and a second FDM component 206. LFAM component 202 may include an interior surface having a LFAM textured shape 203 and an exterior surface 207. LFAM component 202 may be configured to receive one or more FDM components. For example, LFAM component 202 may be configured to receive first FDM component 204. FDM component 204 may include an exterior surface having a textured shape 209 that may be complementary (e.g., having an inverse shape) to LFAM textured shape 203. Additionally, or alternatively, FDM component 204 may include an interior surface having a textured shape 211. In some embodiments, FDM component 204 may be flexible (e.g., configured to flex or bend without breaking in one or more dimensions). For example, FDM component 204 may have gaps, slits, spaces, or the like that enable portions of FDM component 204 to compress or deform under stress. In some embodiments, FDM component 204 may have one or more extension members 208. An extension member may refer to a flexure, such as a projection, finger, strut, or the like. Extension members 208 may allow for a degree of flexibility in FDM component 204. For example, the width (e.g., diameter) of FDM component 204 may be based on the width of LFAM component 202, and extension members 208 may flex upon insertion of FDM component 204 into LFAM component 202, such that the FDM component does not break while providing rigidity and a tight fit (e.g., a friction fit between FDM textured shape 209 and LFAM textured shape 203). In an example, the width of FDM component 204 may be slightly greater than the width of LFAM component 202. In some embodiments, second FDM component 206 may have a textured shape 213, which may be located on the exterior of FDM component 206. For example, textured shape 213 may be complementary to textured shape 211 of FDM component 204. As an example, apparatus 200 can be used to mount a LFAM façade panel into a wall-mounted FDM fitting, or to secure components of furniture together.

FIG. 2B illustrates a cross-sectional view of an apparatus 200 for attaching additive manufactured components, consistent with embodiments of the present disclosure. FIG. 2B may illustrate apparatus 200 in an operative configuration. In some embodiments, apparatus 200 may have a substantially cylindrical shape. For example, a cross section of FDM component 204 may be circular or ovular, and FDM component 204 may be disposed within LFAM component 202. FDM component 204 may be coupled (e.g., attached, fixed, connected, mated, engaged, joined, or the like) to LFAM component 202. For example, the complementary textures between textured shape 209 of FDM component 204 and textured shape 203 of the interior of LFAM component 202 may provide a friction fit, thereby mating the components. In some embodiments, apparatus 200 may include second FDM component 206 having textured shape 213, which may be complementary to textured shape 211 of FDM component 204. Accordingly, there may be a friction fit between the exterior surface of FDM component 206 and the interior surface of FDM component 204. It will be appreciated that such friction fit between FDM component 206 and FDM component 204 may provide pressure on FDM component 204, which may result in added contact pressure between FDM component 204 and LFAM component 202, thereby increasing the security of the fit throughout apparatus 200. Thus, it will be appreciated that the disclosed embodiments provide a secure fit while reducing the use of fasteners or adhesives between components. In an example, FDM component 204 may have a circular cross section at the bottom (e.g., a portion of FDM component 204 from which extension members 208 extend from).

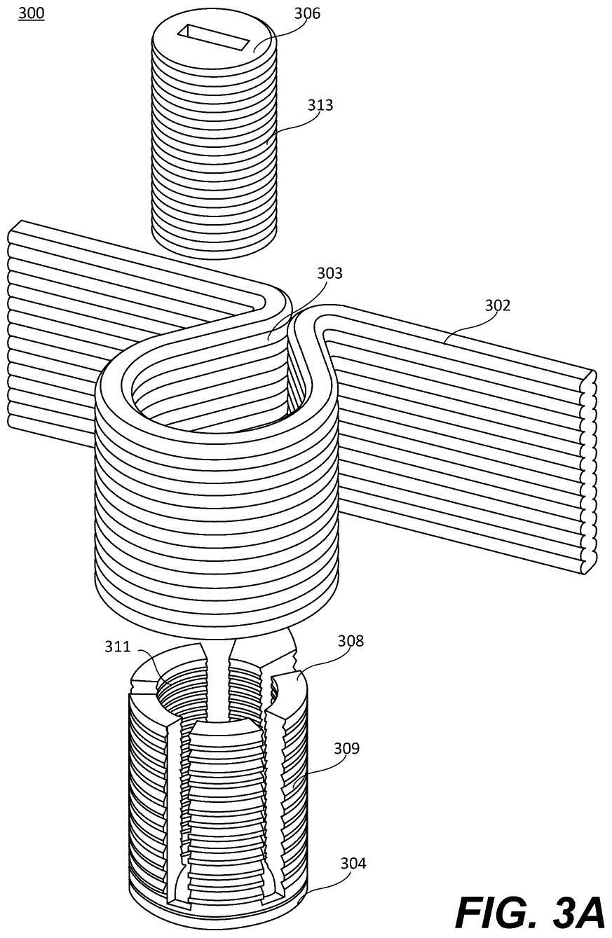

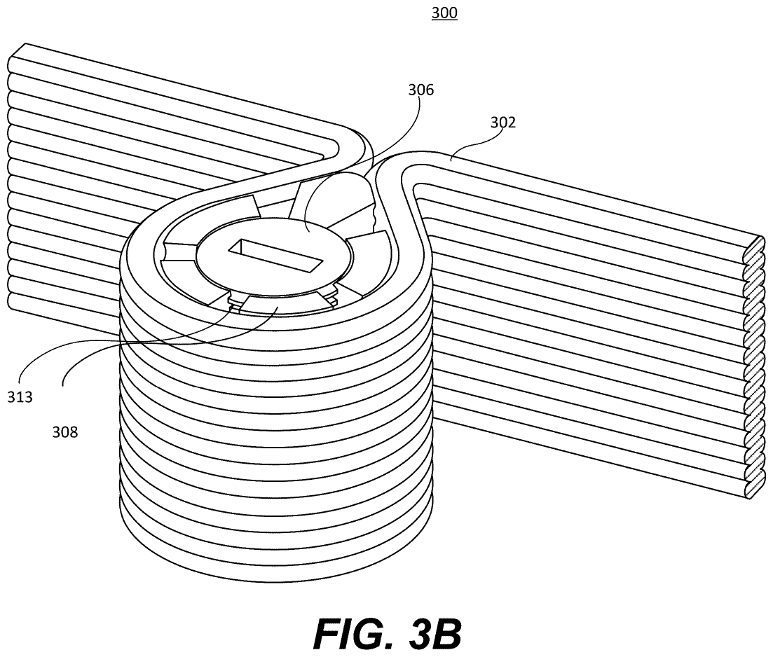

FIG. 3A illustrates an exploded view of an apparatus 300 for attaching additive manufactured components, consistent with embodiments of the present disclosure. Apparatus 300 may include a LFAM component 302, a first FDM component 304, and a second FDM component 306. LFAM component 302 may include an interior surface having a LFAM textured shape 303. LFAM component 302 may be configured to receive one or more FDM components. For example, LFAM component 302 may be configured to receive first FDM component 304. FDM component 304 may include an exterior surface having a textured shape 309 that may be complementary (e.g., having an inverse shape) to LFAM textured shape 203. Additionally, or alternatively, FDM component 304 may include an interior surface having a textured shape 311. In some embodiments, FDM component 304 may be flexible. In some embodiments, FDM component 304 may have one or more extension members 308. Extension members 308 may allow for a degree of flexibility in FDM component 304. In some embodiments, second FDM component 306 may have a textured shape 313, which may be located on the exterior of FDM component 306. For example, textured shape 313 may be complementary to textured shape 311 of FDM component 304.

FIG. 3B illustrates a view of apparatus 300 for attaching additive manufactured components, consistent with embodiments of the present disclosure. In some embodiments, FDM components may be contained within LFAM component 302. For example, extension members 308 of FDM component 304 (not shown) may be coupled to LFAM component 302. In some embodiments, apparatus 300 may include second FDM component 306 having textured shape 313, which may be complementary to a textured shape of extension members 308. Accordingly, there may be a friction fit between the exterior surface of FDM component 306 and the interior surface of extension members 308 (and thereby FDM component 304).

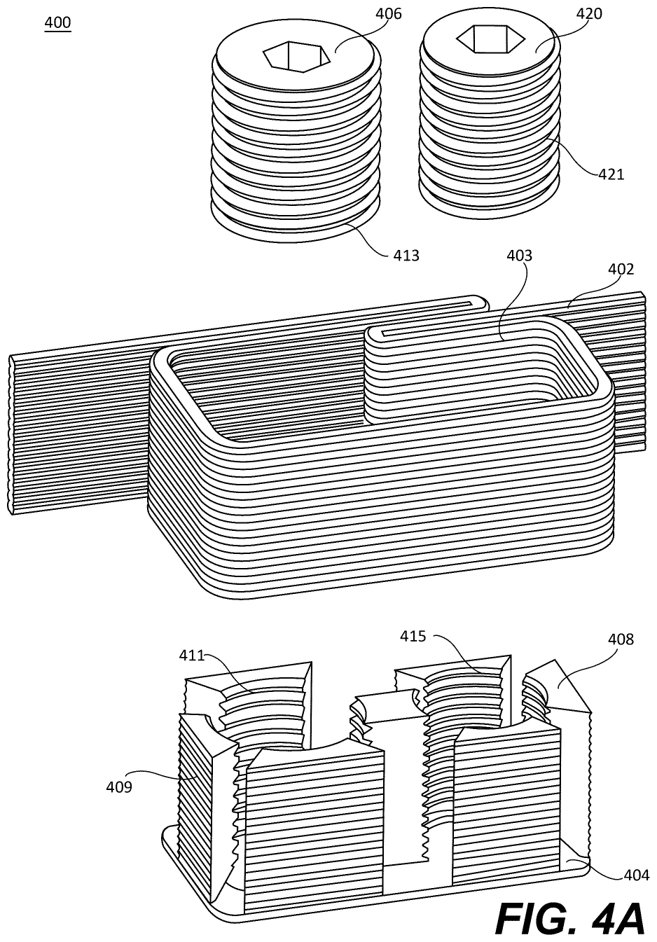

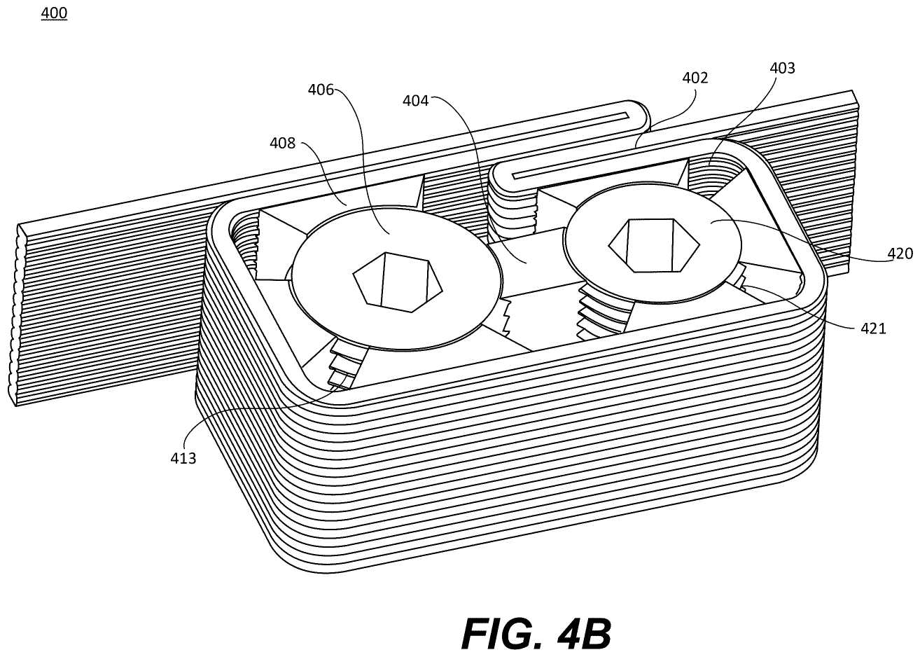

FIG. 4A illustrates an exploded view of an apparatus 400 for attaching additive manufactured components, consistent with embodiments of the present disclosure. It will be appreciated that LFAM components as described herein are not limited to a particular shape or configuration. The disclosed embodiments may include any LFAM component with textured shapes along interior or exterior surfaces. For example, apparatus 400 may include an LFAM component with a rectangular cross-section. In some embodiments, apparatus 400 may include an LFAM component 402, a first FDM component 404, a second FDM component 406, and a third FDM component 420. LFAM component 402 may include an interior surface having a LFAM textured shape 403. LFAM component 402 may be configured to receive one or more FDM components. For example, LFAM component 402 may be configured to receive first FDM component 404. FDM component 404 may include an exterior surface having a textured shape 409 that may be complementary (e.g., having an inverse shape) to LFAM textured shape 403. Additionally, or alternatively, FDM component 404 may include an interior surface having a textured shape 411. In some embodiments, FDM component 404 may be flexible. In some embodiments, FDM component 404 may have one or more extension members 408. Extension members 408 may allow for a degree of flexibility in FDM component 404. Apparatus 400 may include additional FDM components based on the configuration of LFAM component 402 and/or FDM component 404. For example, FDM component 404 may be configured to receive second FDM component 406 that has an exterior surface with a textured shape 413 complementary to textured shape 411. Additionally, FDM component 404 may be configured to receive third FDM component 420 that has an exterior surface with a textured shape 421 complementary to textured shape 415 of FDM component 404, and textured shape 415 may be different or similar to textured shape 411. The disclosed embodiments may also include fourth, fifth, sixth, or more FDM components (e.g., to provide a tighter fit). It will also be appreciated that second FDM component 406 or third FDM component 420 need not be cylindrical as illustrated. For example, FDM component 404 may include extension members 408 forming a triangular or rectangular perimeter, and the corresponding second FDM component may be triangular or rectangular so FDM component 404 may receive it.

FIG. 4B illustrates a view of apparatus 400 for attaching additive manufactured components, consistent with embodiments of the present disclosure. In some embodiments, FDM components may be contained within LFAM component 402. For example, extension members 408 of FDM component 404 may be coupled to LFAM component 402. In some embodiments, apparatus 400 may include second FDM component 406 having textured shape 413, which may be complementary to a textured shape of extension members 408. In some embodiments, apparatus 400 may include third FDM component 420 having textured shape 421. Second FDM component 406 and third FDM component 420 may be disposed within the perimeter of extension members 408, which may be disposed within LFAM component 402. Accordingly, there may be a friction fit between the exterior surface of FDM components 406, 420 and the interior surface of extension members 408 (and thereby FDM component 404) to provide a secure fit between the FDM components and LFAM component 402.

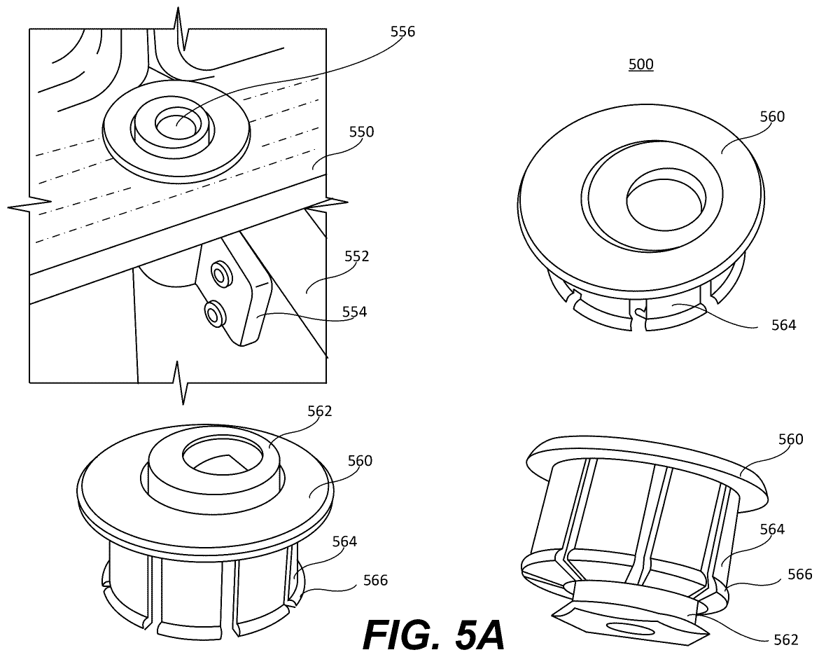

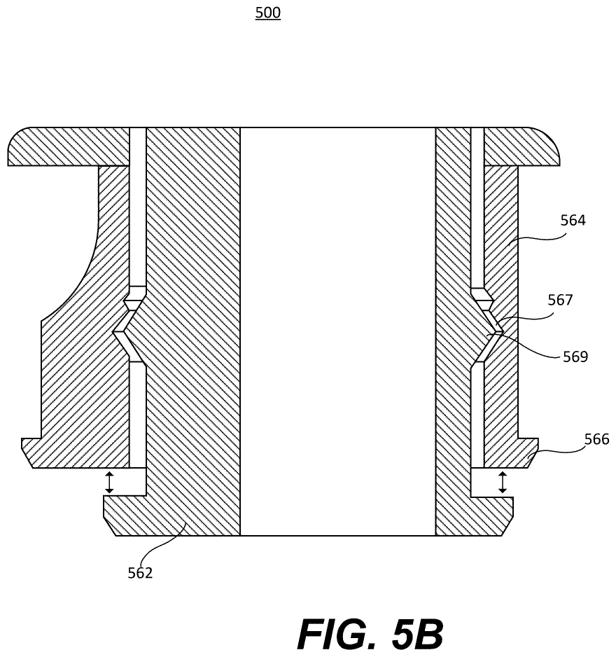

FIG. 5A illustrates views of apparatus 500 for connecting additive manufactured components to furniture, consistent with embodiments of the present disclosure. As described herein, exemplary uses cases of LFAM can include furniture. For example, furniture may include a cabinet with a top surface 550 comprising LFAM, and the top surface 550 may be connected to a hinge 554 of a cabinet door 552 with apparatus 500. In some embodiments, apparatus 500 may include a first FDM component 560 having extension members 564 with hooks 566. Hooks 566 may refer to a textured surface, flange, or lip. Apparatus 500 may include second FDM component 562, which may extend through first FDM component 560. Apparatus 500 may be disposed in top surface 550, and the first FDM component 560 may be connected (e.g., coupled) to hinge 554, thereby enabling cabinet door 552 to rotate about an axis of the hinge. For example, hooks 566 may contact the inner circumference of hinge 554, thereby providing a friction fit that couples hinge 554 to FDM component 560. In some embodiments, apparatus 500 may include a projection member, such as a dowel or rod disposed within second FDM component 562.

FIG. 5B illustrates a cross-sectional view of apparatus 500, consistent with embodiments of the present disclosure. Extension members 564 may include a textured shape 567 that may contact textured shape 569 of second FDM component 562. In some embodiments, textured shape 569 may be complementary to textured shape 567, thereby providing a friction fit. In some embodiments, second FDM component 562 may be used to adjust the friction fit. For example, FDM component 562 may be raised or lowered to contact the bottom of hooks 566, thereby modulating the amount of contact between the textured shapes and consequently modulating the amount of flexure.

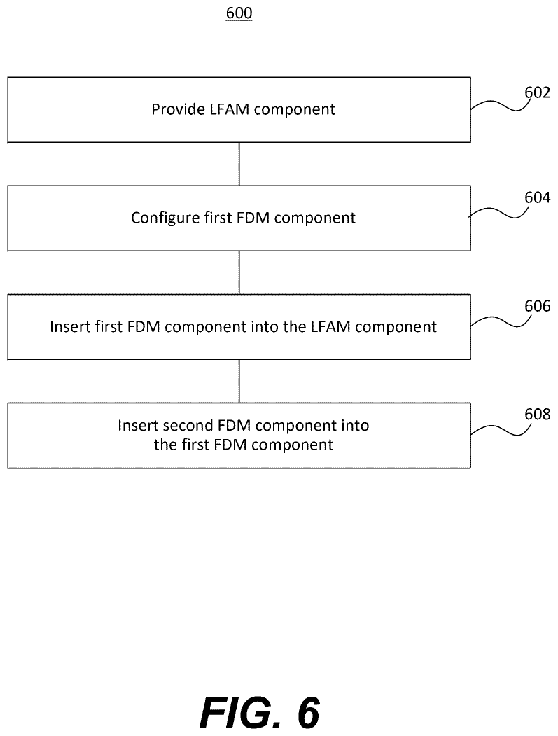

FIG. 6 illustrates a flow chart of a process 600 for connecting additive manufactured components, consistent with embodiments of the present disclosure. Process 600 may include assembling an apparatus for attaching additive manufactured components. In some embodiments, process 600 may include a step 602 of providing a LFAM component. The LFAM component may include a LFAM interior surface, and the LFAM interior surface may have a LFAM texture shape.

In some embodiments, process 600 may include a step 604 of configuring one or more FDM component(s). For example, step 604 may involve configuring a first FDM component and/or a second FDM component. Configuring a FDM component may involve configuring the shape, size, and/or texture of a FDM component. The shape or size of a FDM component may be based on the component(s) it may contact. For example, the shape of a FDM component disposed in a LFAM component may be based on the shape of the LFAM component (e.g., the FDM component may be circular or rectangular depending on the LFAM component receiving it), and the size of the FDM component may be determined to align with the size of the LFAM component. Configuring a FDM component may also involve configuring the textured shape of a FDM component. As described herein, LFAM components may have a textured shape due to the stacking of layers formed in the material extrusion/printing process. For example, based on the nozzle size of the extruder and material of the LFAM, the size and shape of the resulting texture can be extrapolated. Additionally, or alternatively, the size or shape of LFAM texture can be measured (e.g., with computer aided-design). For example, the dimensions of each individual layer, such as the height/thickness of a layer or the arc length (e.g., when a ridge of a layer is circular or pill-shaped), can be measured (such as dimensions 190 as referenced in FIG. 1), including with measurement tools available in CAD software. Based on such dimensions, step 604 may involve designing a FDM component that has complementary or inverse layers. For example, a FDM component (e.g., component 104) may be configured in a CAD software to have a texture with flat portions to align with peaks of the LFAM component as well as ridges to align with indented portions of the LFAM component. It will be appreciated that the geometry of the textured shapes of layers are not limited to a specific shape, as the disclosed embodiments can include geometries that are trapezoidal, rectangular, circular, triangular, or the like.

In some embodiments, process 600 may involve a step 606 of inserting a FDM component into the LFAM component. As described herein, LFAM components may be configured to receive one or more FDM components (e.g., on an interior of the LFAM component). Inserting the FDM component into the LFAM component may include bringing the FDM component and the LFAM component together such that LFAM component receives the FDM component, thereby creating a friction fit between the LFAM component and the FDM component. The LFAM component and the FDM component may be coupled due to complementary textured shapes between the two (e.g., reducing sliding between the FDM component and the LFAM component). For example, inserting may involve pressing or pushing the components together (e.g., by manual force, with the use of tools such as hammers, or with a machine press). Additionally, or alternatively, inserting may involve rotating or turning of parts, such as by hand, with hand tools, or power tools, as examples. It will be appreciated that since FDM components as described herein may have flexibility, the FDM components may be inserted without breaking or chipping.

In some embodiments, process 600 may involve a step 608 of inserting a second FDM component into the first FDM component. A first FDM component may receive, on its interior, one or more additional FDM components. The additional (e.g., second, third, or more) FDM components may be configured according to the first FDM component. For example, a textured shape of an exterior surface of a second FDM component may be designed to be complementary to an interior surface of the first FDM component, including with the use of CAD tools as described herein. Accordingly, there may be a friction fit between the second FDM component and the first FDM component. As described herein, inserting components may involve turning or rotating components, such as rotating components to mate them along a threaded fit. In some embodiments, process 600 may additionally involve recycling the apparatus comprising the LFAM component and FDM components. For example, process 600 may include end-of-life processing or material recovery for an apparatus including mixed LFAM and FDM components, such as by shredding, grinding, or melting the apparatus into smaller components (e.g., new filament or pellets).

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. An apparatus for attaching additive manufactured components, the apparatus comprising:
a large format additive manufacturing (LFAM) component having a LFAM interior surface, wherein the LFAM interior surface has a LFAM textured shape;
a first fused deposition modeling (FDM) component having a first exterior surface and a first interior surface, wherein the first FDM component is coupled to the LFAM component and the first exterior surface has a first textured shape that is complementary to the LFAM textured shape; and
a second fused deposition modeling (FDM) component having a second exterior surface, wherein the second FDM component is coupled to the first FDM component.

2. The apparatus of claim 1, wherein the first exterior surface of the first FDM component is configured according to one or more layers of the LFAM component.

3. The apparatus of claim 1, further comprising a friction fit between the LFAM interior surface and the first exterior surface of the first FDM component.

4. The apparatus of claim 1, further comprising a friction fit between the first interior surface of the first FDM component and the second exterior surface of the second FDM component.

5. The apparatus of claim 1, wherein the first FDM component is flexible.

6. The apparatus of claim 5, wherein the first FDM component comprises at least one extension member.

7. The apparatus of claim 1, wherein a cross-section of the first FDM component is circular or ovular.

8. The apparatus of claim 1, wherein the LFAM component comprises Acrylonitrile styrene acrylate.

9. A method for connecting additive manufactured components, the method comprising:
providing a large format additive manufacturing (LFAM) component having a LFAM interior surface, wherein the LFAM interior surface has a LFAM textured shape;
configuring a first fused deposition modeling (FDM) component having a first exterior surface and a first interior surface, wherein the first FDM component is coupled to the LFAM component and the first exterior surface has a first textured shape configured to be complementary to the LFAM textured shape; and
inserting the first FDM component into the LFAM component; and
inserting a second fused deposition modeling (FDM) component into the first FDM component, wherein the second FDM component has a second exterior surface and the second FDM component is coupled to the first FDM component.

10. The method of claim 9, wherein the first exterior surface of the first FDM component is configured according to one or more layers of the LFAM component.

11. The method of claim 9, further comprising a friction fit between the LFAM interior surface and the first exterior surface of the first FDM component.

12. The method of claim 9, further comprising a friction between the first interior surface of the first FDM component and the second exterior surface of the second FDM component.

13. The method of claim 9, wherein the first FDM component is flexible.

14. The method of claim 9, wherein the first FDM component comprises at least one extension member.

15. The method of claim 9, wherein a cross-section of the first FDM component is circular.

16. The method of claim 9, wherein the LFAM component comprises Acrylonitrile styrene acrylate.
